(19) United States
(12) Patent Application Publication
(10) Pub. No.: US 2025/0246366 A1
(43) Pub. Date: Jul. 31, 2025

(54) ELECTRICAL ROTARY TRANSFORMER FOR INDUCTIVE ENERGY TRANSFER

(71) Applicant: MAHLE International GmbH, Stuttgart (DE)

(72) Inventors: Gustavo Esteves Albieri, Murrhardt (DE); Thorsten Grelle, Stuttgart (DE); Christoph Schmuelling, Waiblingen (DE); Penyo Topalov, Stuttgart (DE)

(21) Appl. No.: 18/870,684

(22) PCT Filed: May 17, 2023
(86) PCT No.: PCT/EP2023/063381

§ 371 Date: Dec. 1, 2024

(30) Foreign Application Priority Data
Jun. 1, 2022 (DE) 102022205618.3

(51) Int. Cl. H01F 38/18; H01F 27/06; H01F 27/24; H01F 27/28; H02J 50/00; H02J 50/10

(52) U.S. Cl. CPC H01F 38/18; H01F 27/06; H01F 27/24; H01F 27/2823; H02J 50/005; H02J 50/10; H01F 2027/065

(57) ABSTRACT

An electric rotary transformer for inductive energy transfer may include a rotary transformer stator, a rotary transformer rotor rotatable relative to the rotary transformer stator about an axis of rotation extending along an axial direction, and a transformer core composed of a magnetic material. The rotary transformer stator may include a primary coil having a primary coil winding. The rotary transformer rotor may include a secondary coil having a secondary coil winding. The secondary coil may be couplable and/or coupled to the primary coil. The transformer core may be arranged in a fixed position relative to the primary coil, and may at least partially surround the primary and secondary coils. The primary and secondary coil windings may be arranged next to each other one of i) along the axial direction and ii) perpendicular to the axial direction, and each may include an electrically conductive strand and/or winding wire.

### CROSS-REFERENCE TO RELATED APPLICATIONS

This application claims priority to International Patent Application No. PCT/EP2023/063381, filed on May 17, 2023, and German Patent Application No. DE 10 2022 205 618.3, filed on Jun. 1, 2022, the contents of both of which are hereby incorporated by reference in their entirety.

### TECHNICAL FIELD

The invention relates to an electrical rotary transformer for inductive power transmission.

### BACKGROUND

So-called externally excited synchronous electrical machines require a direct electrical current in their rotor to generate the magnetic rotor field. This process is called “rotor excitation”. In conventional synchronous electrical machines, the electrical rotor current is transmitted to the rotating rotor as a DC voltage using carbon brush-slip ring contacts. The disadvantage of this is that the carbon brushes wear down at high speeds due to wear and tear, creating unwanted electrically conductive carbon dust.

As an alternative to such a transmission of the electrical direct current with the help of slip rings, it is known to realize the electrical power transmission inductively, that is, wirelessly, on the rotating rotor. When part of an externally excited synchronous electrical machine, this type of structure is also referred to as a “rotary transformer”.

The functional principle of the aforementioned inductive voltage or energy transmission is based on an electric transformer, wherein the primary winding or primary coil of the transformer is stationary and the secondary winding or secondary coil is on the rotating rotor. Since an alternating voltage is always initially generated in the secondary coil during inductive energy transfer, it is necessary to convert the generated alternating voltage into a rectified voltage.

### SUMMARY

One of the purposes of the present invention is to show new ways of developing rotary transformers. In particular, an improved embodiment of such a rotary transformer is to be created, which is characterized by a simple structure and yet allows the rotary transformer rotor to rotate at high speed-this property is also known to the relevant expert as “high speed stability”.

This object is achieved by the subject matter of the independent claim(s). Preferred embodiments are the subject matter of the dependent claim(s).

The basic idea of the invention is therefore to equip both a stator-side primary coil and a secondary coil, which can be rotated around an axis of rotation in relation to the primary coil and is thus a rotor-side secondary coil of a rotary transformer, with a coil winding made of an electrically conductive strand or an electrically conductive winding wire. Such coil windings can carry high electrical currents and therefore allow the transmission of high power from the stator to the rotor, which rotates around the axis of rotation relative to the stator. The fact that both the primary coil and the secondary coil are wound coils also makes it possible to arrange the two coils directly adjacent to one another, either axially in the direction of the axis of rotation or radially, i.e., in a direction perpendicular to the axis of rotation. This achieves an especially good magnetic and thus inductive coupling of the two coils, which has a favorable effect on the efficiency of the power transmission. According to the invention, the magnetic coupling between the primary and secondary coils is also guided through a transformer core that is arranged in a fixed position relative to the primary coil and at least partially surrounds both the primary coil and the secondary coil.

In detail, an electrical rotary transformer according to the invention comprises a rotary transformer stator having a primary coil. Furthermore, the rotary transformer comprises a rotary transformer rotor having a secondary coil, which is designed to be rotatable relative to the rotary transformer stator about an axis of rotation extending along an axial direction. The secondary coil can be coupled inductively to the primary coil for the transmission of energy from the primary coil to the secondary coil. The primary coil comprises a primary coil winding that can be electrically energized. The secondary coil includes an electrically energizable secondary coil winding. The secondary coil can be or is inductively coupled to the primary coil. This means that when the primary coil is energized with an alternating current, an alternating voltage is induced in the secondary coil. In the rotary transformer according to the invention, the primary coil winding and the secondary coil winding are arranged next to each other along the axial direction or perpendicular to the axial direction. In the second alternative, the secondary coil is preferably arranged radially on the inside and the primary coil consequently radially on the outside, relative to the axis of rotation. This facilitates the torsion-proof attachment of the secondary coil to a rotary transformer rotor shaft that can rotate around the axis of rotation. The primary coil winding and the secondary coil winding of the rotary transformer according to the invention each have an electrically conductive strand or each comprise an electrically conductive winding wire. In particular, the primary or secondary coil winding can be formed by an enameled wire, stranded wire, or the like. Finally, the rotary transformer comprises a transformer core made of a magnetic material, which is arranged in a fixed position relative to the primary coil and at least partially surrounds the primary coil and the secondary coil. Preferably, the transformer core is arranged coaxially to the axis of rotation.

In a preferred embodiment of the rotary transformer according to the invention, the primary coil winding and the secondary coil winding each run, preferably several times, around the axis of rotation.

The material of the transformer core can be a ferrite. Such a soft magnetic material is particularly suitable for influencing the magnetic field that is generated between the two coils when the rotary transformer is in operation. Since the transformer core is fixed in relation to the primary coil and does not follow the rotation of the secondary coil, there is no risk of damage to the mechanically brittle ferrite due to the centrifugal forces acting during rotation.

In a preferred embodiment, the primary coil winding and/or the secondary coil winding is/are arranged on a ring-shaped primary coil or secondary coil winding support that extends around the axis of rotation. The transformer core also has a ring-shaped geometry and has a central longitudinal axis that extends coaxially with the axis of rotation. In particular, the primary coil or secondary coil winding support can be arranged as a ring-shaped support plate or can include such a plate, which is preferably arranged concentrically to the axis of rotation. The use of a toroidal geometry counteracts unwanted imbalances when the rotary transformer rotor turns with the secondary coil. Alternatively, the primary coil winding and/or the secondary coil winding can also be arranged on a hollow cylindrical or cylindrical, i.e., extending in the axial direction and running in the peripheral direction around the axis of rotation, primary coil winding support or secondary coil winding support. This alternative makes assembly easier.

According to a favorable further development of the rotary transformer according to the invention, the transformer core has, in a longitudinal section along the axial direction, two core elements axially opposite each other, as well as a radially inner and a radially outer core element, which together at least partially surround a core interior.

The primary coil and the secondary coil are preferably arranged opposite each other in the core interior, either axially or radially. Both variants ensure effective magnetic coupling of the two coils, i.e., the primary coil and the secondary coil. This increases the efficiency of the electrical energy transfer from the primary coil to the secondary coil. In addition, the first variant requires particularly little radial space, whereas the second variant requires particularly little axial space. This means that the optimum variant in terms of the available space can be selected without sacrificing the magnetic coupling between the two coils.

According to a further advantageous further development, an opening is formed in the radially inner core element of the transformer core, through which an attachment section of the secondary coil, in particular the coil former, for attaching the secondary coil to a synchronous electrical machine rotor shaft, passes radially inwards towards the axis of rotation. In this training, the secondary coil can be easily attached to the rotor shaft, which is arranged outside the transformer core and can rotate, without the effect of the transformer core on the magnetic field generated by the coils being compromised.

In another preferred embodiment, the rotary transformer rotor, in particular the secondary coil, can be designed without a transformer core, in particular without ferrite. This means that the rotary transformer can also be operated at high speeds of its rotary transformer rotor without risking damage to the rotating transformer core. Furthermore, experimental investigations have shown that by eliminating a transformer core acting as a heat store on the rotary transformer rotor, waste heat generated during operation can be better dissipated from the rotary transformer rotor.

According to a favorable training, the rotary transformer has a coaxial to the axis of rotation arranged, with respect to the transformer core and the primary coil rotatable rotary transformer rotor shaft, which is rotationally fixed to the secondary coil. In this way, the rotary transformer can be easily mounted in a synchronous electrical machine, in particular by connecting the rotary transformer rotor shaft to the synchronous electrical machine rotor shaft in a torsionally rigid manner. The rotor shaft of the synchronous electrical machine can also be used as the rotor shaft of the rotary transformer.

According to another advantageous further development, the secondary coil is electrically connected to an electric rectifier circuit of the rotary transformer rotor, which is arranged on a printed circuit board and comprises at least one rectifier element, preferably two or four rectifier elements, for rectifying an alternating voltage electrically induced in the secondary coil. This measure supports the electrical rectification of the alternating voltage induced in the secondary coil, so that it is suitable as a rectified electrical voltage for generating a magnetic rotor field, as required in the rotary transformer rotor of an externally excited synchronous electrical machine. Rectifier diodes or rectifier transistors, in particular MOSFETs, can be used as rectifier elements. The printed circuit board can be connected to the rotary transformer rotor shaft of the rotary transformer in a torsion-resistant manner. Furthermore, the printed circuit board can be arranged axially adjacent to the secondary coil or its winding support.

The rectifier circuit is preferably arranged radially on the inside of the printed circuit board. This may also apply to other electrical/electronic components of the rotor electronics connected downstream of the rectifier circuit. This minimizes the moment of inertia generated by the rectifier elements or the rotor electronics when the rotary transformer rotor shaft and thus the printed circuit board rotate, further improving the speed stability of the rotary transformer. In this context, the term “radially inward” means that, in an axial view of the printed circuit board, the rectifier elements and the rotor electronics are each arranged at least closer to an inner peripheral side of the printed circuit board than to an outer peripheral side of the printed circuit board. It is also possible to arrange all or some of the electronic components, in particular those of the rotor electronics, in the rotary transformer rotor shaft or, alternatively, to transfer them to an additional, separate rotor printed circuit board.

At least one rectifier element is usefully arranged on a top side and/or on a bottom side of the printed circuit board opposite the top side. This applies particularly to all existing rectifier elements. This measure facilitates the assembly of the rotary transformer rotor.

According to a favorable training, the printed circuit board is arranged on a supporting structure that can be attached to a rotary transformer rotor shaft. The supporting structure can be designed as a supporting plate, which is particularly preferred. Such a support structure allows the printed circuit board to be securely attached to the rotary transformer rotor shaft in a torsion-resistant manner and, if suitably designed, also facilitates the assembly of the rotary transformer rotor shaft and printed circuit board to form the rotary transformer rotor of the rotary transformer.

The invention also relates to an externally excited synchronous electrical machine, in particular a traction motor for a vehicle. The synchronous electrical machine according to the invention comprises an electrically energizable synchronous electrical machine stator for generating a magnetic stator field. Furthermore, the rotary transformer comprises an electrically energizable synchronous electrical machine rotor that can rotate relative to the synchronous electrical machine stator for generating a magnetic rotor field, which has a synchronous electrical machine rotor shaft. Furthermore, the synchronous electrical machine according to the invention comprises an electrical rotary transformer, which is connected in a rotationally fixed manner to the synchronous electrical machine rotor shaft. The advantages of the rotary transformer according to the invention as explained above therefore also apply to the synchronous electrical machine according to the invention.

The synchronous electrical machine according to the invention can be used in particular in a motor vehicle, which may comprise a battery as an energy source. In this case, the synchronous electrical machine is used in particular to drive the motor vehicle, so it is designed in particular as a traction motor. Preferably, the traction motor according to the invention has an output or drive power of at least 3 kW, preferably at least 30 kW. The traction motor according to the invention preferably has an output or drive power between 30 kW and 500 kW, most preferably between 100 kW and 300 kW. In the traction motor according to the invention, waste heat, which is produced in much greater quantities in the traction motor according to the invention than in electric motors with lower output power, can be dissipated particularly effectively via the transformer core present in the rotary transformer stator.

Further important features and advantages of the invention can be seen from the sub-claims, the drawing, and the associated figure description based on the drawings.

It is understood that the features mentioned above and those to be explained below can be used not only in the respective combination given, but also in other combinations or on their own, without departing from the scope of the present invention.

Preferred exemplary embodiments of the invention are shown in the drawings by way of example and will be explained in more detail in the following description, wherein identical reference signs refer to identical or similar or functionally identical elements.

### BRIEF DESCRIPTION OF THE DRAWINGS

The following is shown-schematically in each case-in the images below:

FIG. 1 shows an example of a rotary transformer according to the invention, in which the primary coil and the secondary coil of the rotary transformer are arranged axially next to each other,

FIG. 2 shows a variant of the example in FIG. 1, in which the primary coil and the secondary coil are arranged radially next to each other,

FIG. 3 shows a variant of the example of FIG. 1 in which the primary coil winding support or secondary coil winding support has a hollow cylindrical geometry,

FIG. 4 shows a variant of the example in FIG. 2 in which the primary coil winding support or secondary coil winding support has a hollow cylindrical geometry.

### DETAILED DESCRIPTION

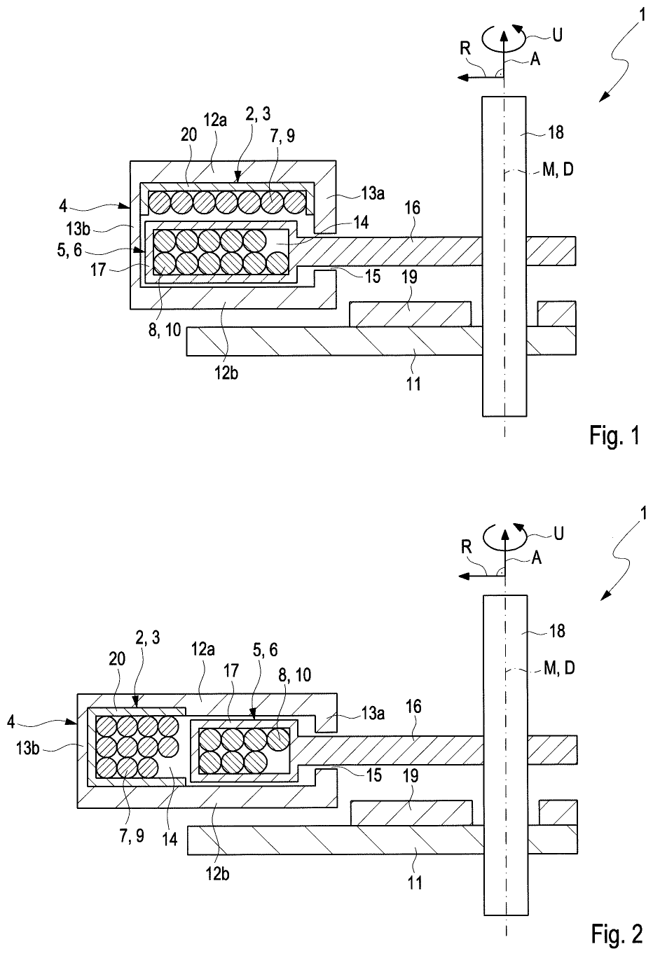

FIG. 1 shows an example of a rotary transformer 1 according to the invention in a longitudinal section. The rotary transformer 1 comprises a rotary transformer stator 3, which has a primary coil 2. Furthermore, the rotary transformer 1 comprises a rotary transformer rotor 6 having a secondary coil 5, which is designed to be rotatable relative to the rotary transformer stator 3 about an axis of rotation D extending along an axial direction A.

The axis of rotation D extends along an axial direction A. A radial direction R extends perpendicular to the axial direction A away from the axis of rotation D. FIG. 1 shows a longitudinal section of the rotary transformer 1 along the axial direction A. A peripheral direction U runs perpendicular to both the axial direction A and the radial direction R around the axis of rotation D.

The secondary coil 5 can be coupled inductively to the primary coil 2 for the transmission of energy from the primary coil 2 to the secondary coil 5. The primary coil 2 includes an electrically energizable primary coil winding 7. The secondary coil 5 includes an electrically energizable secondary coil winding 8. The primary coil winding 7 and the secondary coil winding 8 are arranged next to each other along the axial direction A. The primary coil winding 7 and the secondary coil winding 8 are each formed by an electrically conductive strand 9, 10. Alternatively, an electrically conductive winding wire can also be provided for the respective strand 9, 10.

Furthermore, the rotary transformer 1 comprises a transformer core 4 made of a magnetic material, which at least partially surrounds the primary coil 2 and the secondary coil 5. The material of the transformer core 4 may be a ferrite. The primary coil winding 7 is arranged on a ring-shaped primary coil winding support 20 that runs in the peripheral direction U around the axis of rotation D. Accordingly, the secondary coil winding 8 is arranged on a ring-shaped secondary coil winding support 17 that runs in a peripheral direction U around the axis of rotation D. In example scenario 4, transformer core 4 also has a ring-shaped geometry and has a central longitudinal axis M that is arranged coaxially with the axis of rotation D. The primary coil winding support 20 and the secondary coil winding support 17 can be designed as ring-shaped support plates that are arranged concentrically to the axis of rotation.

As shown in FIG. 1, the rotary transformer 1 also has a rotary transformer rotor shaft 18, which is arranged coaxially to the axis of rotation D and can rotate relative to the transformer core 4 and the primary coil 2, and which is connected to the secondary coil 5 so that it cannot rotate. In the longitudinal section along the axial direction A shown, the transformer core 4 has two core elements 12a, 12b axially opposite one another, as well as a radially inner and a radially outer core element 13a, 13b, which together at least partially surround a core interior 14.

As can be seen in FIG. 1, the primary coil 2 and the secondary coil 5 are axially opposite each other in the core interior 14. In the radially inner core element 13a of the transformer core 4, an opening 15 is formed, through which an attachment section 16 of the secondary coil winding support 17 of the secondary coil 5 engages, for the rotationally fixed attachment of the secondary coil to a synchronous electrical machine rotor shaft, radially inwards towards the axis of rotation D.

The secondary coil 5 can be electrically connected to an electrical rectifier circuit 19 arranged on a printed circuit board 11 (schematically indicated in FIG. 1) (also only roughly schematically indicated in FIG. 1), which comprises a plurality of rectifier elements (not shown) for rectifying the alternating voltage electrically induced in the secondary coil 5. The electrical connection required for this between the rectifier circuit 19 and the secondary coil 5 has been left out of FIG. 1 for reasons of clarity.

The printed circuit board 11 can be arranged axially adjacent to the secondary coil 5 or its secondary coil winding support 17, as shown in FIG. 1. The printed circuit board 11 is connected to the rotary transformer rotor shaft 18 in a torsion-resistant manner and is attached to it.

FIG. 2 shows a variant of the example in FIG. 1. The rotary transformer 1 according to FIG. 2 differs from that of FIG. 2 in that in the case of the rotary transformer 1 of FIG. 2, the primary coil 2 and the secondary coil 5 are located radially—i.e., not axially as in the example of FIG. 1—in the core interior 14 opposite each other. In both the example of FIG. 1 and the example of FIG. 2, the secondary coil 5 of the rotary transformer rotor 6 is designed without a transformer core, i.e., without magnetic material and thus in particular without ferrite.

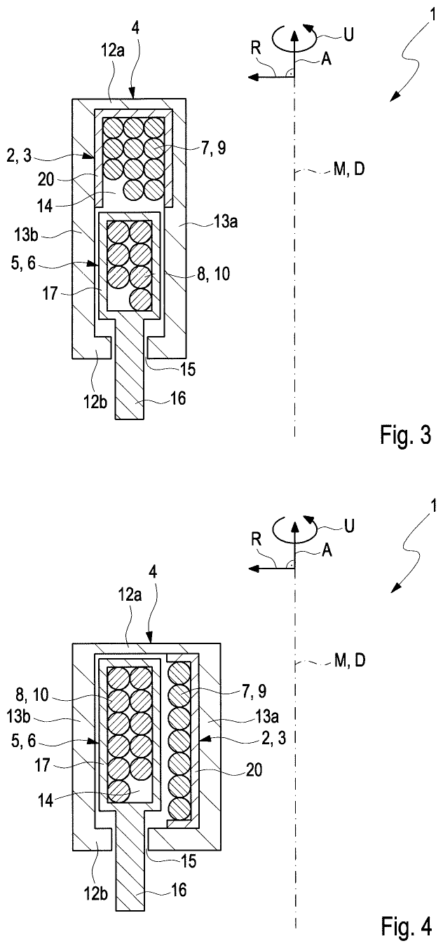

FIGS. 3 and 4 are representations corresponding to FIGS. 1 and 2. In contrast to the example of FIG. 3, the primary coil winding support 20 and the secondary coil winding support 17 do not extend in a radial direction, so that they can form an annular support plate, as in the example of FIGS. 1 and 2, but rather extend both along the peripheral direction U and in the axial direction A. The primary coil winding support 20 and the secondary coil winding support 17 thus have the geometry of a hollow cylinder or cylinder, at least in sections, in the example of FIGS. 3 and 4. The opening 15 formed in the transformer core 4 extends along the axial direction A, as does the attachment section 16 of the secondary coil winding support 17 that passes through the opening 15.

1. An electric rotary transformer for inductive energy transfer, comprising:
a rotary transformer stator including a primary coil;
a rotary transformer rotor rotatable relative to the rotary transformer stator about an axis of rotation extending along an axial direction, the rotary transformer rotor including a secondary coil that is at least one of i) inductively couplable and ii) coupled to the primary coil;
a transformer core composed of a magnetic material, the transformer core arranged in a fixed position relative to the primary coil and at least partially surrounding the primary coil and the secondary coil;
the primary coil including an electrically energizable primary coil winding;
the secondary coil including an electrically energizable secondary coil winding; and
wherein the primary coil winding and the secondary coil winding are arranged next to each other one of i) along the axial direction and ii) perpendicular to the axial direction, and each includes at least one of i) an electrically conductive strand and ii) at least one electrically conductive winding wire.

2. The rotary transformer according to claim 1, wherein the primary coil winding and the secondary coil winding each extend around the axis of rotation.

3. The rotary transformer according to claim 1, wherein the magnetic material of the transformer core is a ferrite.

4. The rotary transformer according to claim 1, wherein at least one of the primary coil winding and the secondary coil winding is arranged on a coil winding support extending in a peripheral direction around the axis of rotation.

5. The rotary transformer according to claim 1, wherein the transformer core has an annular geometry and a central longitudinal axis arranged coaxially to the axis of rotation.

6. The rotary transformer according to claim 1, wherein the transformer core includes, in a longitudinal section extending along the axial direction, two axially opposite core elements, a radially inner core element, and a radially outer core element, which together at least partially surround a core interior.

7. The rotary transformer according to claim 6, wherein the primary coil and the secondary coil are arranged one of axially and radially opposite each other in the core interior.

8. The rotary transformer according to claim 6, wherein the transformer core further includes an opening disposed in the radially inner core element through which an attachment section of the secondary coil, via which the secondary coil is connectable to a synchronous electrical machine rotor shaft, extends radially inwards towards the axis of rotation.

9. The rotary transformer according to claim 1, wherein the rotary transformer rotor does not include a transformer core.

10. The rotary transformer according to claim 1, further comprising a rotary transformer rotor shaft arranged coaxially to the axis of rotation, rotatable relative to the transformer core and the primary coil, and connected to the secondary coil in a rotationally fixed manner.

11. The rotary transformer according to claim 1, wherein:
the rotary transformer rotor further includes a printed circuit board having an electrical rectifier circuit with at least one rectifier element configured to rectify an alternating voltage electrically induced in the secondary coil; and
the secondary coil is electrically connected to the electrical rectifier circuit.

12. An externally excited synchronous electrical machine, comprising:
an electrically energizable synchronous electrical machine stator configured to provide a magnetic stator field;
an electrically energizable synchronous electrical machine rotor rotatable relative to the synchronous electrical machine stator to provide a magnetic rotor field, the synchronous electrical machine rotor including a synchronous electrical machine rotor shaft; and
an electrical rotary transformer according to claim 1, which is non-rotatably connected to the synchronous electrical machine rotor shaft.

13. The synchronous electrical machine according to claim 12, wherein the synchronous electrical machine has at least one of an output and a drive power of at least 3 kW.

14. The rotary transformer according to claim 1, wherein:
the primary coil winding is arranged on a primary coil winding support extending around the axis of rotation in a peripheral direction; and
the secondary coil winding is arranged on a secondary coil winding support extending around the axis of rotation in the peripheral direction.

15. The rotary transformer according to claim 14, wherein at least one of the primary coil winding support and the secondary coil winding support is configured as an annular support plate.

16. The rotary transformer according to claim 14, wherein at least one of the primary coil winding support and the secondary coil winding support is configured as a hollow cylindrical body.

17. The rotary transformer according to claim 14, wherein:
the secondary coil winding support includes i) an attachment section connectable to a synchronous electrical machine rotor shaft and ii) an interior space in which the secondary coil winding is arranged;
the primary coil winding support includes a first wall, a second wall, and a third wall, the first wall extending between and connecting the second wall and the third wall; and
the first wall of the primary coil winding support extends one of radially and axially, and the second wall and the third wall of the primary coil winding support each project the other one of radially and axially from the first wall forming a U-shape.

18. The rotary transformer according to claim 17, wherein:
the secondary coil winding support further includes a first axial wall, a second axial wall, a first radial wall, and a second radial wall that collectively define the interior space; and
the attachment section projects radially inwards toward the axis of rotation from an exterior circumferential surface of the first axial wall of the secondary coil winding support.

19. The rotary transformer according to claim 17, wherein:
the secondary coil winding support further includes a first axial wall, a second axial wall, a first radial wall, and a second radial wall that collectively define the interior space; and
the attachment section projects axially from an exterior surface of the first radial wall of the secondary coil winding support.

20. The rotary transformer according to claim 2, wherein the primary coil winding and the secondary coil winding each revolve around the axis of rotation a plurality of times.
